(19) United States
(12) Patent Application Publication
(10) Pub. No.: US 2026/0079256 A1
(43) Pub. Date: Mar. 19, 2026

(54) TOTAL INTERNAL REFLECTION (TIR) SCANNING DEVICE

(71) Applicant: AEVA, INC., Mountain View, CA (US)

(72) Inventors: Cameron HOWARD, Bend, OR (US); Keith GAGNE, Santa Clara, CA (US); Bradley Scot LEVIN, San Jose, CA (US)

(21) Appl. No.: 19/391,625

(22) Filed: Nov. 17, 2025

Related U.S. Application Data
(63) Continuation of application No. 18/104,006, filed on Jan. 31, 2023.

(51) Int. Cl. G01S 17/34; G01S 7/481; G01S 17/931; G02B 26/10; G02B 26/12

(52) U.S. Cl. CPC G01S 17/34; G01S 7/4817; G02B 26/105; G02B 26/123; G01S 17/931

(57) ABSTRACT

An apparatus includes an optical scanner including a reflective surface and a rear surface, where the optical scanner is mounted to rotate about a scanner. The apparatus includes a control system operatively coupled to the optical scanner. The apparatus includes a motor, operatively coupled to the control system, mounted in proximity to the optical scanner and having a shaft coupled to the optical scanner. The shaft rotates about a shaft axis parallel to the scanner axis causing the optical scanner to rotate about the scanner axis responsively to rotation of the shaft. The motor rotates the optical scanner to each of a set of positions at a respective time based on instructions from the control system. The apparatus includes an optical beam source, operatively coupled to the control system, positioned behind the optical scanner and configured to transmit an optical beam toward the optical scanner while the motor rotates.

### CROSS REFERENCE TO RELATED APPLICATION(S)

This application is a continuation of U.S. patent application Ser. No. 18/104,006, filed on Jan. 31, 2023 and entitled “TOTAL INTERNAL REFLECTION (TIR) SCANNING DEVICE”, the entire contents of which are incorporated herein by reference.

### TECHNICAL FIELD

The present disclosure relates generally to optical detection, and more particularly to systems and methods for producing a field of view in a frequency modulated continuous wave (FMCW) light detection and ranging (LIDAR) system.

### BACKGROUND

In a coherent LIDAR system, an FMCW transmitted light source (Tx) is used to determine the distance and velocity of objects in the scene by mixing a copy of the Tx source, known as the local oscillator (LO), with the received light (Rx) from the scene. The LO and Rx paths are combined on a fast photodiode (e.g., a photodetector), producing beat frequencies, proportional to object distance, which are processed electronically to reveal distance and velocity information of objects in the scene. To generate a point-cloud image, scanning optics (scanners) are commonly used to deflect the Tx beam (e.g., signal) through the system FOV, comprising azimuth and zenith angles.

Conventional scanners, however, require for an expensive, high-performance finish on each side of the scanning device to reflect (instead of refracting) optical beams out to free-space and back without degrading the optical beam. The optical source beams must also come from beside the scanner (or reflect off multiple surfaces) to achieve the required pointing direction from the scanner, instead of behind the scanning device. Furthermore, the “origin” of the point cloud is recessed from the front window of the LIDAR enclosure because of geometric (e.g., height, width) limitations of the conventional scanner.

### SUMMARY

One aspect disclosed herein is directed to a frequency modulated continuous wave (FMCW) light detection and ranging (LIDAR) system. The system includes a multi-sided scanner (sometimes referred to as, total internal reflection (TIR) scanner) including a plurality of sides. The multi-sided scanner is configured to rotate in a same direction at a plurality of different times to produce a plurality of rotational positions. The system includes an optical source configured to transmit, at a first angle relative to a field of view (FOV) window at a first rotational position of the multi-sided scanner, an optical beam towards a first side of the plurality of sides to cause a first portion of the optical beam to traverse the first side to produce a first adjusted beam transmitted within the multi-sided scanner towards a second side of the plurality of sides to produce a second adjusted beam. A trajectory of the second adjusted beam traverses a third side of the plurality of sides to exit the multi-sided scanner to produce a first field of view (FOV) portion (sometimes referred to as, beam pointing direction). The optical source is further configured to transmit, at the first angle at a second rotational position of the multi-sided scanner, the optical beam towards the first side to cause a second portion of the optical beam to traverse the first side to produce a third adjusted beam transmitted within the multi-sided scanner towards the second side to produce a fourth adjusted beam. A trajectory of the fourth adjusted beam traverses the third side of the plurality of sides to exit the multi-sided scanner to produce a second FOV portion. The first adjusted beam, the second adjusted beam, the third adjusted beam, and the fourth adjusted beams are each relative to a normal of a respective side of the multi-sided scanner. The optical source does not move to a different angle (optical source angle) each time it transmits; rather, the angle of the beam hitting the surface of the multi-sided scanner changes because the multi-sided scanner has rotated to a new angle for each transmission.

In another aspect, the present disclosure is directed to a method of producing a FOV in an FMCW LIDAR system. The method includes rotating a multi-sided scanner in a same direction at a plurality of different times to produce a plurality of rotational positions. The multi-sided scanner includes a plurality of sides. The method includes transmitting, at a first angle relative to a field of view (FOV) window at a first rotational position of the multi-sided scanner, an optical beam towards a first side of the plurality of sides to cause a first portion of the optical beam to traverse the first side to produce a first adjusted beam transmitted within the multi-sided scanner towards a second side of the plurality of sides to produce a second adjusted beam. A trajectory of the second adjusted beam traverses a third side of the plurality of sides to exit the multi-sided scanner to produce a first FOV portion. The method includes transmitting, at the first angle relative to a field of view (FOV) window at a first rotational position of the multi-sided scanner, the optical beam towards the first side to cause a second portion of the optical beam to traverse the first side to produce a third adjusted beam transmitted within the multi-sided scanner towards the second side to produce a fourth adjusted beam. A trajectory of the fourth adjusted beam traverses the third side of the plurality of sides to exit the multi-sided scanner to produce a second FOV portion. The first adjusted beam, the second adjusted beam, the third adjusted beam, and the fourth adjusted beams are each relative to a normal of a respective side of the multi-sided scanner. The optical source does not move to a different angle (optical source angle) each time it transmits; rather, the angle of the beam hitting the surface of the multi-sided scanner changes because the multi-sided scanner has rotated to a new angle for each transmission.

In another aspect, the present disclosure is directed to an FMCW LIDAR system. The FMCW LIDAR system includes a multi-sided scanner including a plurality of sides. The FMCW LIDAR system includes an optical source configured to transmit, at a first angle relative to a field of view (FOV) window at a first rotational position of the multi-sided scanner, an optical beam towards a first side of the plurality of sides to cause a first portion of the optical beam to traverse the first side to produce a first adjusted beam transmitted within the multi-sided scanner towards a second side of the plurality of sides to produce a second adjusted beam. A trajectory of the second adjusted beam traverses a third side of the plurality of sides to exit the multi-sided scanner to produce a first field of view (FOV) portion. The FMCW LIDAR system includes transmit, at the first angle at a second rotational position of the multi-sided scanner, the optical beam towards the first side to cause a second portion of the optical beam to traverse the first side to produce a third adjusted beam transmitted within the multi-sided scanner towards the second side to produce a fourth adjusted beam. A trajectory of the fourth adjusted beam traverses the third side of the plurality of sides to exit the multi-sided scanner to produce a second FOV portion. The FMCW LIDAR system includes a window positioned adjacent to the multi-sided scanner and configured to directly receive the second adjusted beam to form the first FOV portion and the second FOV portion. The first adjusted beam, the second adjusted beam, the third adjusted beam, and the fourth adjusted beams are each relative to a normal of a respective side of the multi-sided scanner. The optical source does not move to a different angle (optical source angle) each time it transmits; rather, the angle of the beam hitting the surface of the multi-sided scanner changes because the multi-sided scanner has rotated to a new angle for each transmission.

These and other features, aspects, and advantages of the present disclosure will be apparent from a reading of the following detailed description together with the accompanying figures, which are briefly described below. The present disclosure includes any combination of two, three, four or more features or elements set forth in this disclosure, regardless of whether such features or elements are expressly combined or otherwise recited in a specific example implementation described herein. This disclosure is intended to be read holistically such that any separable features or elements of the disclosure, in any of its aspects and example implementations, should be viewed as combinable unless the context of the disclosure clearly dictates otherwise.

It will therefore be appreciated that this summary is provided merely for purposes of summarizing some example implementations so as to provide a basic understanding of some aspects of the disclosure. Accordingly, it will be appreciated that the above described example implementations are merely examples and should not be construed to narrow the scope or spirit of the disclosure in any way. Other example implementations, aspects, and advantages will become apparent from the following detailed description taken in conjunction with the accompanying figures which illustrate, by way of example, the principles of some described example implementations.

### BRIEF DESCRIPTION OF THE FIGURES

Embodiments and implementations of the present disclosure will be understood more fully from the detailed description given below and from the accompanying drawings of various aspects and implementations of the disclosure, which, however, should not be taken to limit the disclosure to the specific embodiments or implementations, but are for explanation and understanding only.

FIG. 1 is a block diagram illustrating an example of a LIDAR system, according to some embodiments;

FIG. 2 is a time-frequency diagram illustrating an example of an FMCW scanning signal that can be used by a LIDAR system to scan a target environment, according to some embodiments;

FIG. 3 is a block diagram illustrating an example environment for producing a field of view in an FMCW LIDAR system using a triangular-shaped optical scanner, according to some embodiments;

FIG. 3A is a block diagram illustrating an example environment for producing a field of view in an FMCW LIDAR system using a triangular-shaped optical scanner, according to some embodiments;

FIG. 3B is a block diagram illustrating the optical beam source 340 in FIG. 3 in another position relative to the triangular-shaped optical scanner, according to some embodiments;

FIG. 4 is a block diagram illustrating an example environment for producing a field of view in an FMCW LIDAR system using a pentagonal-shaped optical scanner, according to some embodiments; and

FIG. 5 is a flow diagram illustrating an example method for producing a field of view in a frequency modulated continuous wave (FMCW) light detection and ranging (LIDAR) system, according to some embodiments.

### DETAILED DESCRIPTION

According to some embodiments, the described LIDAR system using programmable beam steering compensation may be implemented in a variety of sensing and detection applications, such as, but not limited to, automotive, communications, consumer electronics, and healthcare markets. According to some embodiments, the described LIDAR system using programmable beam steering compensation may be implemented as part of a front-end of an FMCW device that assists with spatial awareness for automated driver assist systems, or self-driving vehicles. According to some embodiments, the disclosed configuration may be agnostic to specific optical scanning architecture and can be tailored to enhance scanning LIDAR performance for a desired target range and/or to increase frame rate for a given range on the fly.

In a coherent LIDAR system, an FMCW transmitted light source (Tx) is used to determine the distance and velocity of objects in the scene by mixing a copy of the Tx source, known as the local oscillator (LO), with the received light (Rx) from the scene. The LO and Rx paths are combined on a fast photodiode (e.g., a photodetector), producing beat frequencies, proportional to object distance, which are processed electronically to reveal distance and velocity information of objects in the scene. To generate a point-cloud image, scanning optics (scanners) are commonly used to deflect the Tx beam (e.g., signal) through the system FOV, comprising azimuth and zenith angles.

Conventional scanners, however, require for an expensive, high-performance finish on each side of the scanning device in order to reflect (instead of refracting) optical beams out to free-space and back without degrading the optical beam. The optical source beams must also come from beside the scanner (or reflect off multiple surfaces) in order to achieve the required pointing direction from the scanner, instead of behind the scanning device. Furthermore, the “origin” of the point cloud is recessed from the front window of the LIDAR enclosure because of geometric (e.g., height, width) limitations of the conventional scanner.

Accordingly, the present disclosure addresses the above-noted and other deficiencies by disclosing systems and methods producing a field of view in a FMCW LIDAR system. As described in the below passages with respect to one or more embodiments, an FMCW LIDAR system includes a multi-sided scanner that includes a plurality of sides. The multi-sided scanner is configured to rotate about an axis and in a same direction at plurality of different times to produce a plurality of rotational positions (e.g., rotational angles). The system includes an optical source that is configured to transmit, at a first angle (e.g., 45 degrees) at a first time (e.g., time 1), an optical beam towards a first side of the plurality of sides to cause a first portion of the optical beam to traverse the first side to produce a first adjusted beam transmitted within the multi-sided scanner towards a second side of the plurality of sides to produce a second adjusted beam. A trajectory of the second adjusted beam traverses a third side of the plurality of sides to exit the multi-sided scanner to produce a first FOV portion. The optical source is further configured to transmit, at a second angle (e.g., 90 degrees) at a second time (e.g., time 2), the optical beam towards the first side to cause a second portion of the optical beam to traverse the first side to produce a third adjusted beam transmitted within the multi-sided scanner towards the second side to produce a fourth adjusted beam. The optical source does not move to a different angle (optical source angle) each time it transmits; rather, the angle of the beam hitting the surface (facet) of the multi-sided scanner changes because the multi-sided scanner has rotated to a new angle for each transmission. A trajectory of the fourth adjusted beam traverses the third side of the plurality of sides to exit the multi-sided scanner to produce a second FOV portion. The first angle and the second angle are each relative to a normal vector (sometimes referred to as a, “normal”) of the first side of the plurality of sides.

The embodiments of the present disclosure may implement various features to provide benefits over the conventional system. The TIR scanner also may use less expensive materials and/or finishes as compared to conventional scanning mirrors. Furthermore, since the TIR scanner is not limited by reflections on exterior surfaces, it is possible to locate the optical beam source in a position behind the TIR scanner. This allows for a smaller, scaled-down LIDAR system. Also, the locations from which the optical beams would leave the TIR scanner would be closer to the front window of the LIDAR system, allowing for a smaller front window and lidar system mechanical size. Lastly, the TIR scanner could be made of various geometries with different numbers of facets in order to alter certain aspects of the scanning FOV.

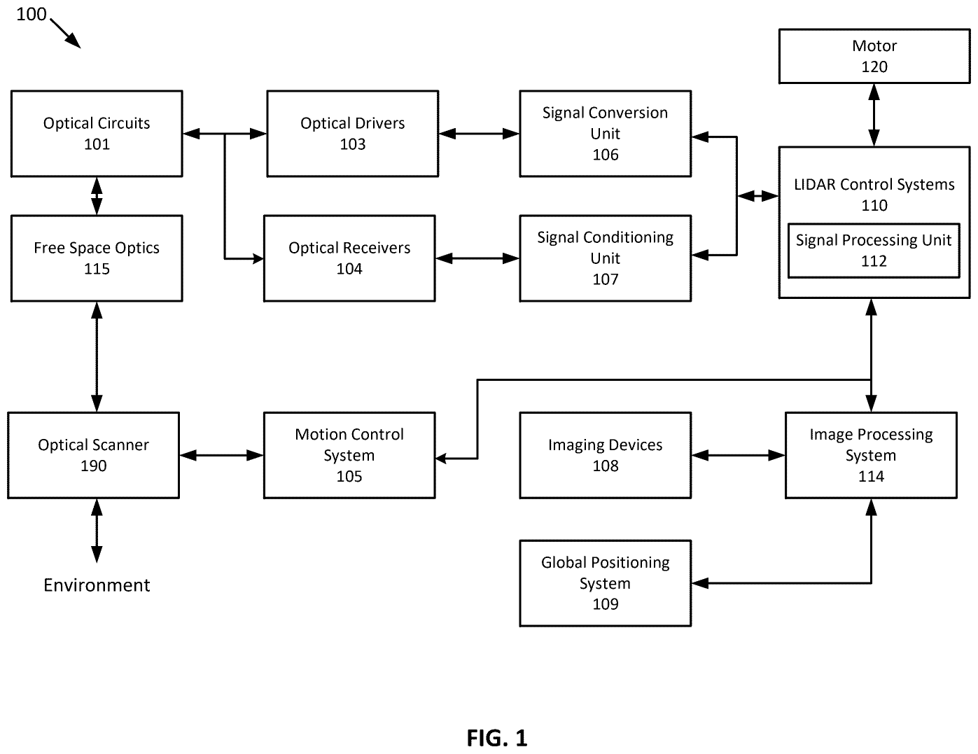

FIG. 1 is a block diagram illustrating an example of a LIDAR system, according to some embodiments. The LIDAR system 100 includes one or more of each of a number of components, but may include fewer or additional components than shown in FIG. 1. One or more of the components depicted in FIG. 1 can be implemented on a photonics chip, according to some embodiments. The optical circuits 101 may include a combination of active optical components and passive optical components. Active optical components may generate, amplify, and/or detect optical signals and the like. In some examples, the active optical component includes optical beams at different wavelengths, and includes one or more optical amplifiers, one or more optical detectors, or the like. In some embodiments, one or more LIDAR systems 100 may be mounted onto any area (e.g., front, back, side, top, bottom, and/or underneath) of a vehicle to facilitate the detection of an object in any free space relative to the vehicle. In some embodiments, the vehicle may include a steering system and a braking system, each of which may work in combination with one or more LIDAR systems 100 according to any information (e.g., distance/ranging information, Doppler information, etc.) acquired and/or available to the LIDAR system 100. In some embodiments, the vehicle may include a vehicle controller that includes the one or more components and/or processors of the LIDAR system 100.

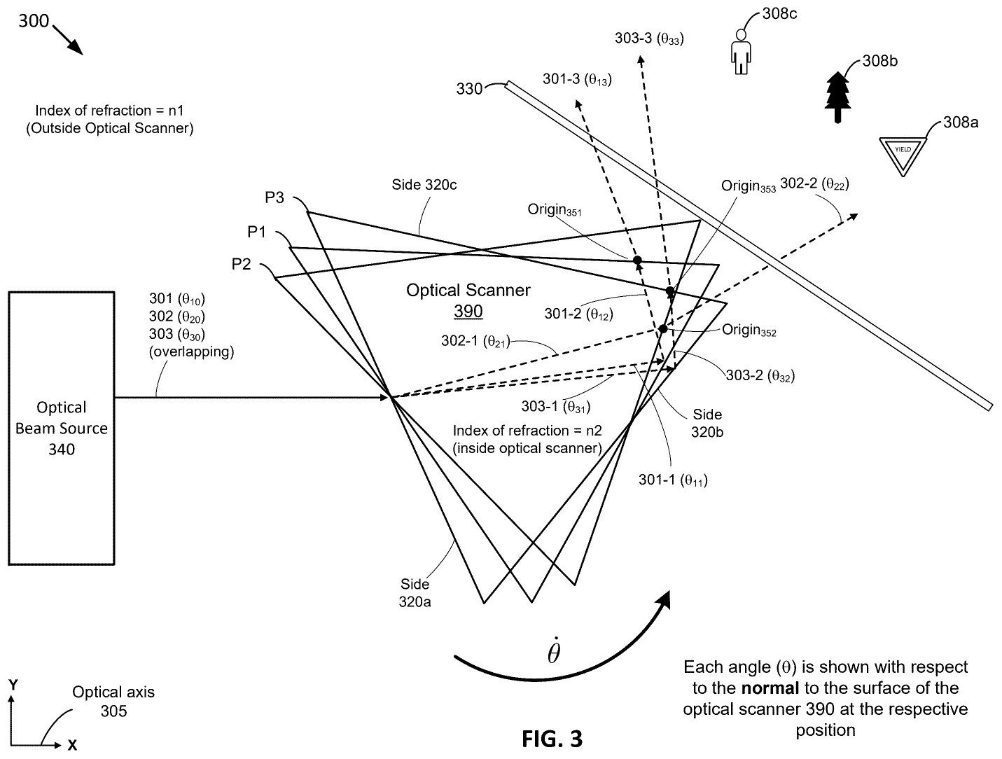

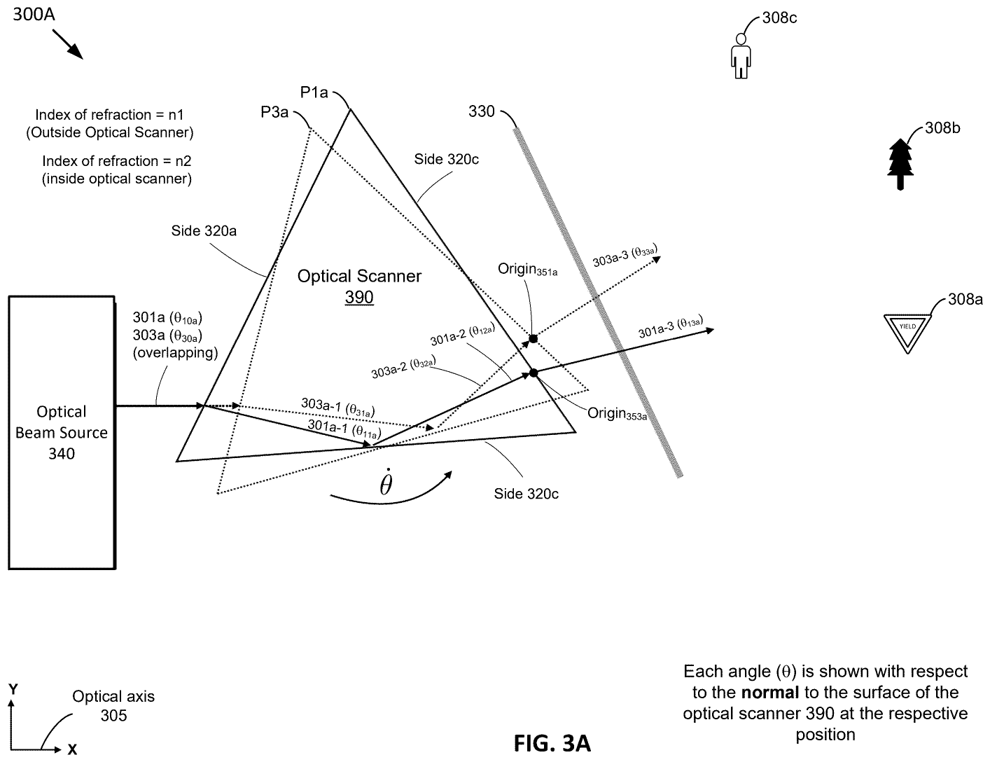

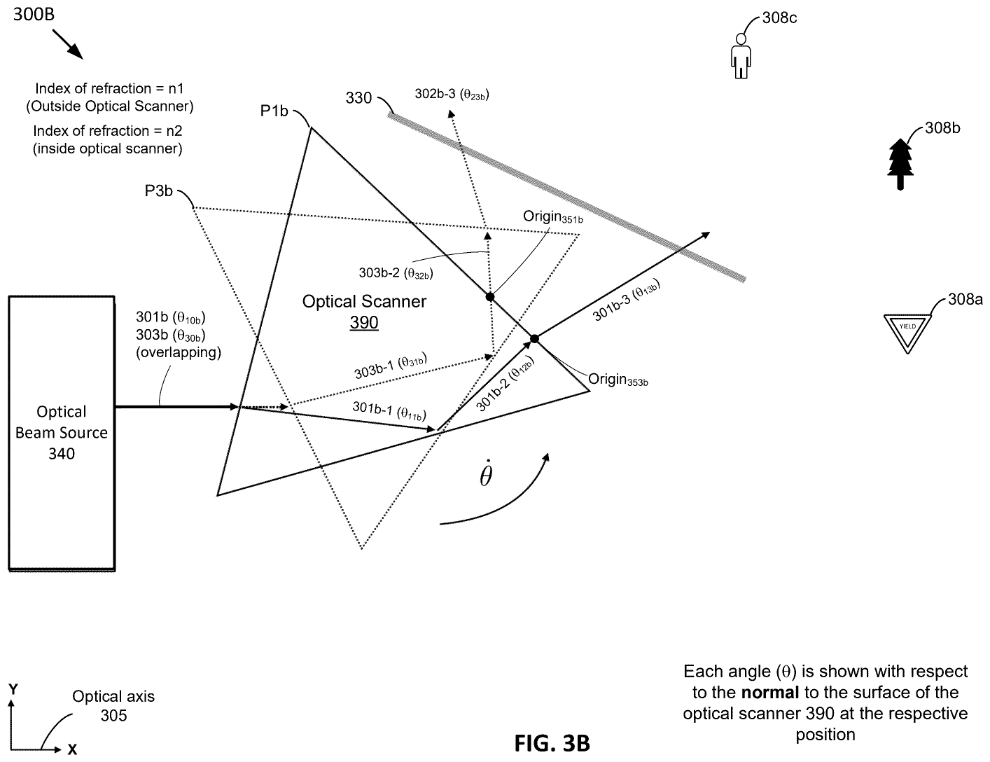

Free space optics 115 may include one or more optical waveguides to carry optical signals, and route and manipulate optical signals to appropriate input/output ports of the active optical circuit. In embodiments, the one or more optical waveguides may include one or more graded index waveguides, as will be described in additional detail below at FIGS. 3-6. The free space optics 115 may also include one or more optical components such as taps, wavelength division multiplexers (WDM), splitters/combiners, polarization beam splitters (PBS), collimators, couplers or the like. In some examples, the free space optics 115 may include components to transform the polarization state and direct received polarized light to optical detectors using a PBS, for example. The free space optics 115 may further include a diffractive element to deflect optical beams having different frequencies at different angles along an axis (e.g., a fast-axis).

In some examples, the LIDAR system 100 includes an optical scanner 190 that includes one or more scanning mirrors that are rotatable along an axis (e.g., a slow-axis) that is orthogonal or substantially orthogonal to the fast-axis of the diffractive element to steer optical signals to scan an environment according to a scanning pattern. For instance, the scanning mirrors may be rotatable by one or more galvanometers. Objects in the target environment may scatter an incident light into a return optical beam or a target return signal. The optical scanner 190 also collects the return optical beam or the target return signal, which may be returned to the passive optical circuit component of the optical circuits 101. For example, the return optical beam may be directed to an optical detector by a polarization beam splitter. In addition to the mirrors and galvanometers, the optical scanner 190 may include components such as a quarter-wave plate, lens, anti-reflective coated window or the like.

To control and support the optical circuits 101 and optical scanner 190, the LIDAR system 100 includes LIDAR control systems 110. The LIDAR control systems 110 may include a processing device for the LIDAR system 100. In some examples, the processing device may be one or more general-purpose processing devices such as a microprocessor, central processing unit, or the like. More particularly, the processing device may be complex instruction set computing (CISC) microprocessor, reduced instruction set computer (RISC) microprocessor, very long instruction word (VLIW) microprocessor, or processor implementing other instruction sets, or processors implementing a combination of instruction sets. The processing device may also be one or more special-purpose processing devices such as an application specific integrated circuit (ASIC), a field programmable gate array (FPGA), a digital signal processor (DSP), network processor, or the like.

In some examples, the LIDAR control system 110 may include a processing device that may be implemented with a DSP, such as signal processing unit 112. The LIDAR control systems 110 are configured to output digital control signals to control optical drivers 103. In some examples, the digital control signals may be converted to analog signals through signal conversion unit 106. For example, the signal conversion unit 106 may include a digital-to-analog converter. The optical drivers 103 may then provide drive signals to active optical components of optical circuits 101 to drive optical sources such as lasers and amplifiers. In some examples, several optical drivers 103 and signal conversion units 106 may be provided to drive multiple optical sources.

The LIDAR control systems 110 are also configured to output digital control signals for the optical scanner 190. A motion control system 105 may control the galvanometers of the optical scanner 190 based on control signals received from the LIDAR control systems 110. For example, a digital-to-analog converter may convert coordinate routing information from the LIDAR control systems 110 to signals interpretable by the galvanometers in the optical scanner 190. In some examples, a motion control system 105 may also return information to the LIDAR control systems 110 about the position or operation of components of the optical scanner 190. For example, an analog-to-digital converter may in turn convert information about the galvanometers' position to a signal interpretable by the LIDAR control systems 110.

The LIDAR control systems 110 are further configured to analyze incoming digital signals. In this regard, the LIDAR system 100 includes optical receivers 104 to measure one or more beams received by optical circuits 101. For example, a reference beam receiver may measure the amplitude of a reference beam from the active optical component, and an analog-to-digital converter converts signals from the reference receiver to signals interpretable by the LIDAR control systems 110. Target receivers measure the optical signal that carries information about the range and velocity of a target in the form of a beat frequency, modulated optical signal. The reflected beam may be mixed with a second signal from a local oscillator. The optical receivers 104 may include a high-speed analog-to-digital converter to convert signals from the target receiver to signals interpretable by the LIDAR control systems 110. In some examples, the signals from the optical receivers 104 may be subject to signal conditioning by signal conditioning unit 107 prior to receipt by the LIDAR control systems 110. For example, the signals from the optical receivers 104 may be provided to an operational amplifier for amplification of the received signals and the amplified signals may be provided to the LIDAR control systems 110.

In some applications, the LIDAR system 100 may additionally include one or more imaging devices 108 configured to capture images of the environment, a global positioning system 109 configured to provide a geographic location of the system, or other sensor inputs. The LIDAR system 100 may also include an image processing system 114. The image processing system 114 can be configured to receive the images and geographic location, and send the images and location or information related thereto to the LIDAR control systems 110 or other systems connected to the LIDAR system 100.

In operation according to some examples, the LIDAR system 100 is configured to use nondegenerate optical sources to simultaneously measure range and velocity across two dimensions. This capability allows for real-time, long range measurements of range, velocity, azimuth, and elevation of the surrounding environment.

In some examples, the scanning process begins with the optical drivers 103 and LIDAR control systems 110. The LIDAR control systems 110 instruct, e.g., via signal processing unit 112, the optical drivers 103 to independently modulate one or more optical beams, and these modulated signals propagate through the optical circuits 101 to the free space optics 115. The free space optics 115 directs the light at the optical scanner 190 that scans a target environment over a preprogrammed pattern defined by the motion control system 105.

The optical circuits 101 may also include a polarization wave plate (PWP) to transform the polarization of the light as it leaves the optical circuits 101. In some examples, the polarization wave plate may be a quarter-wave plate or a half-wave plate. A portion of the polarized light may also be reflected back to the optical circuits 101. For example, lensing or collimating systems used in LIDAR system 100 may have natural reflective properties or a reflective coating to reflect a portion of the light back to the optical circuits 101.

Optical signals reflected back from an environment pass through the optical circuits 101 to the optical receivers 104. Because the polarization of the light has been transformed, it may be reflected by a polarization beam splitter along with the portion of polarized light that was reflected back to the optical circuits 101. In such scenarios, rather than returning to the same fiber or waveguide serving as an optical source, the reflected signals can be reflected to separate optical receivers 104. These signals interfere with one another and generate a combined signal. The combined signal can then be reflected to the optical receivers 104. Also, each beam signal that returns from the target environment may produce a time-shifted waveform. The temporal phase difference between the two waveforms generates a beat frequency measured on the optical receivers 104 (e.g., photodetectors).

The analog signals from the optical receivers 104 are converted to digital signals by the signal conditioning unit 107. These digital signals are then sent to the LIDAR control systems 110. A signal processing unit 112 may then receive the digital signals to further process and interpret them. In some embodiments, the signal processing unit 112 also receives position data from the motion control system 105 and galvanometers (not shown) as well as image data from the image processing system 114. The signal processing unit 112 can then generate 3D point cloud data (sometimes referred to as, “a LIDAR point cloud”) that includes information about range and/or velocity points in the target environment as the optical scanner 190 scans additional points. In some embodiments, a LIDAR point cloud may correspond to any other type of ranging sensor that is capable of Doppler measurements, such as Radio Detection and Ranging (RADAR). The signal processing unit 112 can also overlay 3D point cloud data with image data to determine velocity and/or distance of objects in the surrounding area. The signal processing unit 112 also processes the satellite-based navigation location data to provide data related to a specific global location.

The LIDAR system 100 includes a motor 120 that is communicatively coupled to the LIDAR control system 110 via a communication interface.

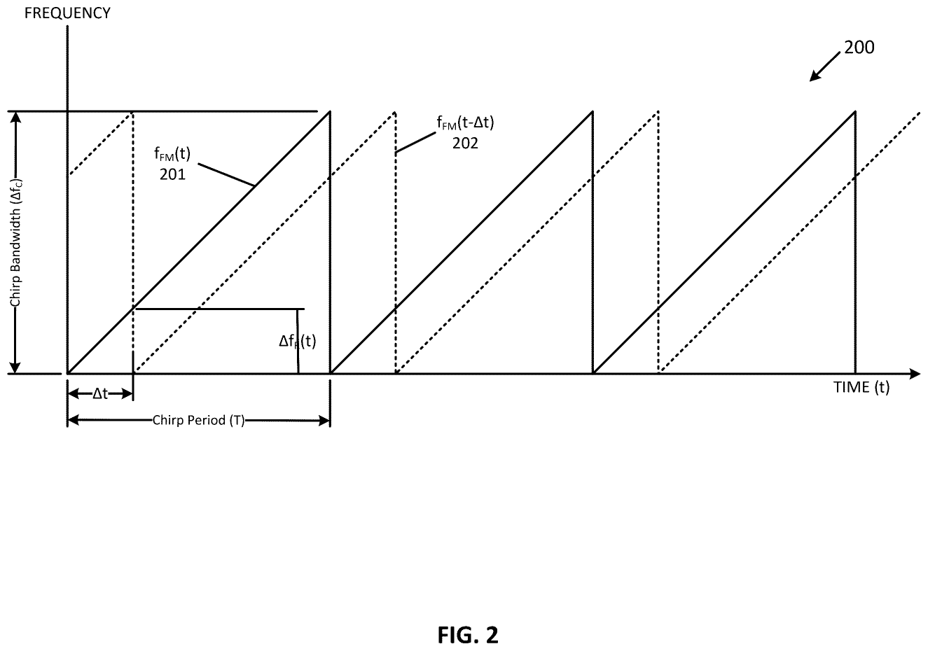

FIG. 2 is a time-frequency diagram illustrating an example of an FMCW scanning signal that can be used by a LIDAR system to scan a target environment, according to some embodiments. In one example, the scanning waveform 201, labeled as f_{FM}(t), is a sawtooth waveform (sawtooth “chirp”) with a chirp bandwidth Δf_{C} and a chirp period T_{C}. The slope of the sawtooth is given as k=(Δf_{C}/T_{C}). FIG. 2 also depicts target return signal 202 according to some embodiments. Target return signal 202, labeled as f_{FM}(t−Δt), is a time-delayed version of the scanning waveform 201, where Δt is the round trip time to and from a target illuminated by scanning waveform 201. The round trip time is given as Δt=2R/v, where R is the target range and v is the velocity of the optical beam, which is the speed of light c. The target range, R, can therefore be calculated as R=c(Δt/2). When the return signal 202 is optically mixed with the scanning signal, a range-dependent difference frequency (“beat frequency”) Δf_{R}(t) is generated. The beat frequency Δf_{R}(t) is linearly related to the time delay Δt by the slope of the sawtooth k. That is, Δf_{R}(t)=kΔt. Since the target range R is proportional to Δt, the target range R can be calculated as R=(c/2)(Δf_{R}(t)/k). That is, the range R is linearly related to the beat frequency Δf_{R}(t). The beat frequency Δf_{R}(t) can be generated, for example, as an analog signal in optical receivers 104 of LIDAR system 100. The beat frequency can then be digitized by an analog-to-digital converter (ADC), for example, in a signal conditioning unit such as signal conditioning unit 107 in LIDAR system 100. The digitized beat frequency signal can then be digitally processed, for example, in a signal processing unit, such as signal processing unit 112 in LIDAR system 100. It should be noted that the target return signal 202 will, in general, also includes a frequency offset (Doppler shift) if the target has a velocity relative to the LIDAR system 100.

The Doppler shift can be determined separately, and used to correct (e.g., adjust, modify) the frequency of the return signal, so the Doppler shift is not shown in FIG. 2 for simplicity and ease of explanation. For example, LIDAR system 100 may correct the frequency of the return signal by removing (e.g., subtracting, filtering) the Doppler shift from the frequency of the returned signal to generate a corrected return signal. The LIDAR system 100 may then use the corrected return signal to calculate a distance and/or range between the LIDAR system 100 and the object. In some embodiments, the Doppler frequency shift of target return signal 202 that is associated with an object may be indicative of a velocity and/or movement direction of the object relative to the LIDAR system 100.

It should also be noted that the sampling frequency of the ADC will determine the highest beat frequency that can be processed by the system without aliasing. In general, the highest frequency that can be processed is one-half of the sampling frequency (i.e., the “Nyquist limit”). In one example, and without limitation, if the sampling frequency of the ADC is 1 gigahertz, then the highest beat frequency that can be processed without aliasing (Δf_{Rmax}) is 500 megahertz. This limit in turn determines the maximum range of the system as Rₘₐₓ=(c/2) (Δf_{Rmax}/k) which can be adjusted by changing the chirp slope k. In one example, while the data samples from the ADC may be continuous, the subsequent digital processing described below may be partitioned into “time segments” that can be associated with some periodicity in the LIDAR system 100. In one example, and without limitation, a time segment might correspond to a predetermined number of chirp periods T, or a number of full rotations in azimuth by the optical scanner.

FIG. 3 is a block diagram illustrating an example environment for producing a field of view in a LIDAR system using a triangular-shaped optical scanner, according to some embodiments. The environment 300 includes the optical scanner 390 (sometimes referred to as, “multi-sided scanner” herein) and an optical beam source 340. The optical scanner 390 (e.g., a prism) may be constructed from, but not limited to, a glass material, a plastic material (e.g., acrylic), a fluorite material, and the like. In some embodiments, each side of the optical scanner 390 can be polished in such a manner to cause the optical scanner 390 to have refracting and/or reflecting characteristics, as described herein.

The environment 300 includes a window 330 of particular dimensions (e.g., a height and a width) that is positioned adjacent to the optical scanner 390. As shown in FIG. 3, the window 330 is positioned in front of the optical scanner 390, and the optical beam source 340 is positioned behind the optical scanner 390 instead of beside the optical scanner 390. In some embodiments, the axis of the optical scanner 390 is positioned at a particular physical location to cause a vertex of the optical scanner 390 to be immediately adjacent to the window 330 for at least a portion of a rotation time for the optical scanner 390 to fully rotate about the axis, where the vertex corresponds to a most-distant vertex of the optical scanner 390 from a centroid of the optical scanner 390.

The window 330 may be a part of an enclosure (not shown in FIG. 1) that encompasses the optical scanner 390 and the optical beam source 340. The dimensions of the window 330 and the positioning of the window 330 relative to the positioning of the optical scanner 390 allows the window 330 to directly receive at least two optical beams (e.g., a second adjusted beam, a fourth adjusted beam) from the optical scanner 390 to form a field of view (FOV). With respect to FIG. 3, the FOV is defined as the range of angles of the optical beams that pass through the window 330.

In some embodiments, any of the components (e.g., optical scanner 390, optical beam source 340, window 330, etc.) in the environment 300 may be added as a component of the LIDAR system 100 in FIG. 1, or be used to replace or modify any of the one or more components (e.g., free space optics 115, optical circuits, optical receivers 104, etc.) of the LIDAR system 100.

The environment 300 includes one or more objects, such as object 308a (e.g., a street sign), object 308b (e.g., a tree), and object 308c (e.g., a pedestrian); each collectively referred to as objects 308. Although FIG. 3 shows only a select number of objects 308, the environment 300 may include any number of objects 308 of any type (e.g., pedestrians, vehicles, street signs, raindrops, snow, street surface) that are within a short distance (e.g., 30 meters) or a long distance (e.g., 300 meters, 500 meters and beyond) from the optical scanner 390 (e.g., 190 in FIG. 1). In some embodiments, an object 308 may be stationary or moving with respect to the optical scanner 390.

The optical scanner 390 is coupled to the motor 120, and the motor 120 is coupled to the LIDAR control system 110 in FIG. 1 via a communication interface. The LIDAR control system 110 sends instructions to the motor 120 via the communication interface to cause the motor 120 to rotate the optical scanner 390 about an axis in a counter-clockwise or clockwise direction across a plurality of different times or time periods (e.g., t1, t2, t3, etc.) in order to cause the optical scanner 390 to be in a plurality of rotational positions (e.g., rotational angles) at a respective time. The motor 120 continuously rotates the optical scanner 390, such that the optical scanner 390 travels multiple rotations (where 1 rotation equals 360 degrees) about the axis. For example, the LIDAR control system 110 in FIG. 1 sends a first set of instructions to the motor 120 to cause the motor 120 to rotate the optical scanner 390 at a first time period (e.g., time 1) in a counter-clockwise direction to be in a first rotational position (shown in FIG. 1, as position 1 (Pl)). The LIDAR control system 110 in FIG. 1 then sends a second set of instructions to the motor 120 to cause the motor 120 to rotate the optical scanner 390 at a second time period (e.g., time 2) in a counter-clockwise direction to be in a second rotational position (shown in FIG. 1, as position 2 (P2)). The LIDAR control system 110 in FIG. 1 then sends a third set of instructions to the motor 120 to cause the motor 120 to rotate the optical scanner 390 at a third time period (e.g., time 3) in a counter-clockwise direction to be in a third rotational position (shown in FIG. 1, as position 3 (P3)). According to some embodiments, the LIDAR control system 110 can send just a single set of instructions that specify the rotations and time periods as described above.

Although FIG. 3 shows only a select number of rotational positions (e.g., P1, P2, P3) for the optical scanner 390, the optical scanner 390 may be in any rotational position at any particular time during its rotation.

Each surface of the optical scanner 390 is configured (based on its material and/or amount of surface polishing) to reflect and/or refract (e.g., change direction of) the optical beams that strike the surface. Whether an optical beam passes through (refracts) a side of the optical scanner 390 or reflects off the side of the optical scanner 390 depends on the angle of the optical beam and the relationship between the refractive index (n₁) of the environment outside of the optical scanner 390 and the refractive index (n2₁) of the environment inside of the optical scanner 390. In some embodiments, the environment outside of the optical scanner 390 is air, which has a refractive index (n₁) of approximately 1.0. In some embodiments, the optical scanner 390 is constructed from a glass material, which has a refractive index (n₂) of approximately 1.50. In some embodiments, the optical scanner 390 is constructed from a plastic material, which has a refractive index (n₂) of 1.3 to 1.6. In some embodiments, the optical scanner 390 is constructed from a fluorite material, which has a refractive index (n₂) of 0.4 to 0.5.

The optical beam source 340 is configured to transmit optical beams along an optical axis 305 (shown in FIG. 3 as the X-axis) toward a side of the optical scanner 390, while the motor rotates the optical scanner 390 about the axis.

The optical beam source 340 may be positioned (e.g., fixed, set, installed) in a position relative to the optical scanner 390 to transmit an optical beam 301 toward a side 320a of the optical scanner 390 when the optical scanner 390 is in rotational position (P1) during a first time period (e.g., time 1). As depicted in FIG. 3, the optical beam 301 strikes the side 320a of the optical scanner 390 at angle (θ₁₀) (sometimes referred to as, “first receiving (Rx) angle”) relative to a first normal vector of the side 320a of the optical scanner 390.

The side 320a of the optical scanner 390 refracts the optical beam 301 based on angle (θ₁₀) to generate an optical beam 301-1 (sometimes referred to as, “first refracted beam”) that propagates (e.g., traverses) through the side 320a of the optical scanner 390 and toward an interior surface of a side 320b of the optical scanner 390. That is, the side 320a refracts the optical beam 301 because the angle (θ₁₀) of the optical beam 301 is less than a predetermined angle relative to the first normal of the side 320a, where the predetermined angle is based on the refractive index (n₁) of the environment that the optical beam 301 is traveling from and the refractive index (n₂) of the environment in which the optical beam 301 is traveling towards.

The optical beam 301-1 has an angle (θ₁₁) (sometimes referred to as, “first refracted angle”) relative to a second normal of the side 320b of the optical scanner 390. In some embodiments, the angle (θ₁₀) of the optical beam 301 is different from the angle (θ₁₁) of the optical beam 301-1.

The side 320b of the optical scanner 390 reflects the optical beam 301-1 based on angle (θ₁₁) to generate an optical beam 301-2 (sometimes referred to as, “first reflected beam”) that propagates towards an interior surface of a side 320c of the optical scanner 390, where the optical beam 301-2 has an angle (θ₂₁) (sometimes referred to as, “first reflected angle”) relative to a third normal of the side 320c of the optical scanner 390. That is, the side 320b reflects the optical beam 301-1 because the angle (θ₁₁) of the optical beam 301-1 is greater than a predetermined angle relative to the second normal of the side 320b. In some embodiments, the angle (θ₁₁) of the optical beam 301-1 is different from the angle (θ₂₁) of the optical beam 301-2.

The side 320c of the optical scanner 390 refracts the optical beam 301-2 based on angle (θ₂₁) to generate an optical beam 301-3 (sometimes referred to as, “second reflected beam”) that propagates through the window 330, and in some embodiments, towards one of the objects 308, where the optical beam 301-3 has an angle (θ₃₁) (sometimes referred to as, “second refracted angle”) relative to a third normal of the side 320c of the optical scanner 390.

The optical beam 301-2 strikes the side 320c of the optical scanner 390 at a point of origin 351 on the side 320c while the optical scanner 390 is in the rotational position (P1), where a first distance between the point of origin 351 and the window 330 is smaller than a second distance between a midpoint on the side 320c and the window 330.

The optical beam source 340 may transmit an optical beam 302 toward the side 320a of the optical scanner 390 when the optical scanner 390 is in rotational position (P2) during a second time period (e.g., time 2). The optical beam 302 strikes the side 320a of the optical scanner 390 at angle (θ₂₀) (sometimes referred to as, “second receiving (Rx) angle”) relative to the first normal vector of the side 320a of the optical scanner 390.

The side 320a of the optical scanner 390 refracts the optical beam 302 based on angle ( [symbol] ) to generate an optical beam 302-1 (sometimes referred to as, “second refracted beam”) that propagates (e.g., traverses) through the side 320a of the optical scanner 390 and toward an interior surface of a side 320b of the optical scanner 390. That is, the side 320a refracts the optical beam 302 because the angle ( [symbol] ) of the optical beam 302 is less than a predetermined angle relative to the first normal of the side 320a, where the predetermined angle is based on the refractive index (n₁) of the environment that the optical beam 302 is traveling from and the refractive index (n₂) of the environment in which the optical beam 302 is traveling towards.

The optical beam 302-1 has an angle ( [symbol] ) (sometimes referred to as, “second refracted angle”) relative to a second normal of the side 320a of the optical scanner 390. In some embodiments, the angle ( [symbol] ) of the optical beam 302-1 is different from the angle ( [symbol] ) of the optical beam 302.

The side 320b of the optical scanner 390 refracts the optical beam 302-1 based on angle ( [symbol] ) to generate an optical beam 302-2 that propagates through the window 330, and in some embodiments, towards one of the objects 308, where the optical beam 302-2 has an angle ( [symbol] ) relative to a second normal of the side 320b of the optical scanner 390.

The optical beam 302-1 strikes the side 320b of the optical scanner 390 at a point of origin 352 on the side 320b while the optical scanner 390 is in the rotational position (P2), where a first distance between the point of origin 352 and the window 330 is smaller than a second distance between a midpoint on the side 320b and the window 330.

The optical beam source 340 may transmit an optical beam 303 toward the side 320a of the optical scanner 390 when the optical scanner 390 is in rotational position (P3) during a third time period (e.g., time 3). The optical beam 303 strikes the side 320a of the optical scanner 390 at angle ( [symbol] ) (sometimes referred to as, “third receiving (Rx) angle”) relative to the first normal vector of the side 320a of the optical scanner 390.

The side 320a of the optical scanner 390 refracts the optical beam 303 based on angle ( [symbol] ) to generate an optical beam 303-1 (sometimes referred to as, “first refracted beam”) that propagates (e.g., traverses) through the side 320a of the optical scanner 390 and toward an interior surface of a side 320b of the optical scanner 390. That is, the side 320a refracts the optical beam 303 because the angle ( [symbol] ) of the optical beam 303 is less than a predetermined angle relative to the first normal of the side 320a, where the predetermined angle is based on the refractive index (n₁) of the environment that the optical beam 303 is traveling from and the refractive index (n₂) of the environment in which the optical beam 303 is traveling towards.

The optical beam 303-1 has an angle ( [symbol] ) (sometimes referred to as, “first refracted angle”) relative to a second normal of the side 320b of the optical scanner 390. In some embodiments, the angle ( [symbol] ) of the optical beam 303-1 is different from the angle ( [symbol] ) of the optical beam 303.

The side 320b of the optical scanner 390 reflects the optical beam 303-1 based on angle ( [symbol] ) to generate an optical beam 303-2 (sometimes referred to as, “first reflected beam”) that propagates towards an interior surface of a side 320c of the optical scanner 390, where the optical beam 303-2 has an angle ( [symbol] ) (sometimes referred to as, “first reflected angle”) relative to a third normal of the side 320c of the optical scanner 390. That is, the side 320b reflects the optical beam 303-1 because the angle ( [symbol] ) of the optical beam 303-1 is greater than a predetermined angle relative to the second normal of the side 320b. In some embodiments, the angle ( [symbol] ) of the optical beam 303-2 is different from the angle ( [symbol] ) of the optical beam 303-1.

The side 320c of the optical scanner 390 refracts the optical beam 303-2 based on angle ( [symbol] ) to generate an optical beam 303-3 (sometimes referred to as, “second reflected beam”) that propagates through the window 330, and in some embodiments, towards one of the objects 308, where the optical beam 303-3 has an angle ( [symbol] ) (sometimes referred to as, “second refracted angle”) relative to a third normal of the side 320c of the optical scanner 390.

The optical beam 303-2 strikes the side 320c of the optical scanner 390 at a point of origin 353 on the side 320c while the optical scanner 390 is in the rotational position (P3), where a first distance between the point of origin 353 and the window 330 is smaller than a second distance between a midpoint on the side 320c and the window 330.

It should be clarified that the optical beam 301 strikes the side 320a of the optical scanner 390 at angle (θ₁₀), optical beam 302 strikes the side 320a of the optical scanner 390 at angle ( [symbol] ), and the optical beam 303 strikes the side 320a of the optical scanner 390 at angle ( [symbol] ) because the multi-sided scanner has rotated to a new angle for each transmission. That is, the optical scanner 390 does not move (or reposition) when transmitting the optical beams 301, 302, 303.

FIG. 3A is a block diagram illustrating an example environment for producing a field of view in an FMCW LIDAR system using a triangular-shaped optical scanner, according to some embodiments.

The optical beam source 340 is configured to transmit optical beams along an optical axis 305 toward a side of the optical scanner 390, while the motor rotates the optical scanner 390 about the axis.

The optical beam source 340 may be positioned in a position relative to the optical scanner 390 to transmit an optical beam 301a toward a side 320a of the optical scanner 390 when the optical scanner 390 is in rotational position (P1a) during a first time period (e.g., time 1). As depicted in FIG. 3A, the optical beam 301a strikes the side 320a of the optical scanner 390 at angle (θ₁₀ₐ) (sometimes referred to as, “first receiving (Rx) angle”) relative to a first normal vector of the side 320a of the optical scanner 390.

The side 320a of the optical scanner 390 refracts the optical beam 301a based on angle (θ₁₀ₐ) to generate an optical beam 301a-1 (sometimes referred to as, “first refracted beam”) that propagates (e.g., traverses) through the side 320a of the optical scanner 390 and toward an interior surface of a side 320b of the optical scanner 390. That is, the side 320a refracts the optical beam 301a because the angle ( [symbol] ) of the optical beam 301a is less than a predetermined angle relative to the first normal of the side 320a, where the predetermined angle is based on the refractive index (n₁) of the environment that the optical beam 301a is traveling from and the refractive index (n₂) of the environment in which the optical beam 301a is traveling towards.

The optical beam 301a-1 has an angle ( [symbol] ) (sometimes referred to as, “first refracted angle”) relative to a second normal of the side 320b of the optical scanner 390. In some embodiments, the angle ( [symbol] ) of the optical beam 301a is different from the angle ( [symbol] ) of the optical beam 301a-1.

The side 320b of the optical scanner 390 reflects the optical beam 301a-1 based on angle ( [symbol] ) to generate an optical beam 301a-2 (sometimes referred to as, “first reflected beam”) that propagates towards an interior surface of a side 320c of the optical scanner 390, where the optical beam 301a-2 has an angle ( [symbol] ) (sometimes referred to as, “first reflected angle”) relative to a third normal of the side 320c of the optical scanner 390. That is, the side 320b reflects the optical beam 301a-1 because the angle ( [symbol] ) of the optical beam 301a-1 is greater than a predetermined angle relative to the second normal of the side 320b. In some embodiments, the angle ( [symbol] ) of the optical beam 301a-1 is different from the angle ( [symbol] ) of the optical beam 301a-2.

The side 320c of the optical scanner 390 refracts the optical beam 301a-2 based on angle ( [symbol] ) to generate an optical beam 301a-3 (sometimes referred to as, “second reflected beam”) that propagates through the window 330, and in some embodiments, towards one of the objects 308, where the optical beam 301a-3 has an angle ( [symbol] ) (sometimes referred to as, “second refracted angle”) relative to a third normal of the side 320c of the optical scanner 390.

The optical beam 301a-2 strikes the side 320c of the optical scanner 390 at a point of origin 351a on the side 320c while the optical scanner 390 is in the rotational position (P1a), where a first distance between the point of origin 351a and the window 330 is smaller than a second distance between a midpoint on the side 320c and the window 330.

The optical beam source 340 may transmit an optical beam 303a toward the side 320a of the optical scanner 390 when the optical scanner 390 is in rotational position (P3a) during a third time period (e.g., time 3). The optical beam 303a strikes the side 320a of the optical scanner 390 at angle ( [symbol] ) (sometimes referred to as, “third receiving (Rx) angle”) relative to the first normal vector of the side 320a of the optical scanner 390.

The side 320a of the optical scanner 390 refracts the optical beam 303a based on angle ( [symbol] ) to generate an optical beam 303a-1 (sometimes referred to as, “first refracted beam”) that propagates (e.g., traverses) through the side 320a of the optical scanner 390 and toward an interior surface of a side 320b of the optical scanner 390. That is, the side 320a refracts the optical beam 303a because the angle ( [symbol] ) of the optical beam 303a is less than a predetermined angle relative to the first normal of the side 320a, where the predetermined angle is based on the refractive index (n₁) of the environment that the optical beam 303a is traveling from and the refractive index (n₂) of the environment in which the optical beam 303a is traveling towards.

The optical beam 303a-1 has an angle ( [symbol] ) (sometimes referred to as, “first refracted angle”) relative to a second normal of the side 320b of the optical scanner 390. In some embodiments, the angle ( [symbol] ) of the optical beam 303a-1 is different from the angle ( [symbol] ) of the optical beam 303a.

The side 320b of the optical scanner 390 reflects the optical beam 303a-1 based on angle ( [symbol] ) to generate an optical beam 303a-2 (sometimes referred to as, “first reflected beam”) that propagates towards an interior surface of a side 320c of the optical scanner 390, where the optical beam 303a-2 has an angle ( [symbol] ) (sometimes referred to as, “first reflected angle”) relative to a third normal of the side 320c of the optical scanner 390. That is, the side 320b reflects the optical beam 303a-1 because the angle ( [symbol] ) of the optical beam 303a-1 is greater than a predetermined angle relative to the second normal of the side 320b. In some embodiments, the angle ( [symbol] ) of the optical beam 303a-2 is different from the angle ( [symbol] ) of the optical beam 303a-1.

The side 320c of the optical scanner 390 refracts the optical beam 303a-2 based on angle ( [symbol] ) to generate an optical beam 303a-3 (sometimes referred to as, “second reflected beam”) that propagates through the window 330, and in some embodiments, towards one of the objects 308, where the optical beam 303a-3 has an angle ( [symbol] ) (sometimes referred to as, “second refracted angle”) relative to a third normal of the side 320c of the optical scanner 390.

The optical beam 303a-2 strikes the side 320c of the optical scanner 390 at a point of origin 353 on the side 320c while the optical scanner 390 is in the rotational position (P3a), where a first distance between the point of origin 353a and the window 330 is smaller than a second distance between a midpoint on the side 320c and the window 330.

FIG. 3B is a block diagram illustrating the optical beam source 340 in FIG. 3 in another position relative to the triangular-shaped optical scanner, according to some embodiments.

The optical beam source 340 is configured to transmit optical beams along an optical axis 305 toward a side of the optical scanner 390, while the motor rotates the optical scanner 390 about the axis.

The optical beam source 340 may be positioned in a position relative to the optical scanner 390 to transmit an optical beam 301b toward a side 320a of the optical scanner 390 when the optical scanner 390 is in rotational position (P1b) during a first time period (e.g., time 1). As depicted in FIG. 3B, the optical beam 301b strikes the side 320b of the optical scanner 390 at angle (θ_{10b}) (sometimes referred to as, “first receiving (Rx) angle”) relative to a first normal vector of the side 320a of the optical scanner 390.

The side 320a of the optical scanner 390 refracts the optical beam 301b based on angle (θ_{10b}) to generate an optical beam 301b-1 (sometimes referred to as, “first refracted beam”) that propagates (e.g., traverses) through the side 320a of the optical scanner 390 and toward an interior surface of a side 320b of the optical scanner 390. That is, the side 320a refracts the optical beam 301b because the angle ( [symbol] ) of the optical beam 301b is less than a predetermined angle relative to the first normal of the side 320a, where the predetermined angle is based on the refractive index (n₁) of the environment that the optical beam 301b is traveling from and the refractive index (n₂) of the environment in which the optical beam 301b is traveling towards.

The optical beam 301b-1 has an angle ( [symbol] ) (sometimes referred to as, “first refracted angle”) relative to a second normal of the side 320b of the optical scanner 390. In some embodiments, the angle ( [symbol] ) of the optical beam 301b is different from the angle ( [symbol] ) of the optical beam 301b-1.

The side 320b of the optical scanner 390 reflects the optical beam 301b-1 based on angle ( [symbol] ) to generate an optical beam 301b-2 (sometimes referred to as, “first reflected beam”) that propagates towards an interior surface of a side 320c of the optical scanner 390, where the optical beam 301b-2 has an angle ( [symbol] ) (sometimes referred to as, “first reflected angle”) relative to a third normal of the side 320c of the optical scanner 390. That is, the side 320b reflects the optical beam 301b-1 because the angle ( [symbol] ) of the optical beam 301b-1 is greater than a predetermined angle relative to the second normal of the side 320b. In some embodiments, the angle ( [symbol] ) of the optical beam 301b-1 is different from the angle ( [symbol] ) of the optical beam 301b-2.

The side 320c of the optical scanner 390 refracts the optical beam 301b-2 based on angle ( [symbol] ) to generate an optical beam 301b-3 (sometimes referred to as, “second reflected beam”) that propagates through the window 330, and in some embodiments, towards one of the objects 308, where the optical beam 301b-3 has an angle ( [symbol] ) (sometimes referred to as, “second refracted angle”) relative to a third normal of the side 320c of the optical scanner 390.

The optical beam 301b-2 strikes the side 320c of the optical scanner 390 at a point of origin 351b on the side 320c while the optical scanner 390 is in the rotational position (P1b), where a first distance between the point of origin 351b and the window 330 is smaller than a second distance between a midpoint on the side 320c and the window 330.

The optical beam source 340 may transmit an optical beam 303b toward the side 320a of the optical scanner 390 when the optical scanner 390 is in rotational position (P3b) during a third time period (e.g., time 3). The optical beam 303b strikes the side 320a of the optical scanner 390 at angle ( [symbol] ) (sometimes referred to as, “third receiving (Rx) angle”) relative to the first normal vector of the side 320a of the optical scanner 390.

The side 320a of the optical scanner 390 refracts the optical beam 303b based on angle ( [symbol] ) to generate an optical beam 303b-1 (sometimes referred to as, “first refracted beam”) that propagates (e.g., traverses) through the side 320a of the optical scanner 390 and toward an interior surface of a side 320b of the optical scanner 390. That is, the side 320a refracts the optical beam 303b because the angle ( [symbol] ) of the optical beam 303b is less than a predetermined angle relative to the first normal of the side 320a, where the predetermined angle is based on the refractive index (n₁) of the environment that the optical beam 303b is traveling from and the refractive index (n₂) of the environment in which the optical beam 303b is traveling towards.

The optical beam 303b-1 has an angle ( [symbol] ) (sometimes referred to as, “first refracted angle”) relative to a second normal of the side 320b of the optical scanner 390. In some embodiments, the angle ( [symbol] ) of the optical beam 303b-1 is different from the angle ( [symbol] ) of the optical beam 303b.

The side 320b of the optical scanner 390 reflects the optical beam 303b-1 based on angle ( [symbol] ) to generate an optical beam 303b-2 (sometimes referred to as, “first reflected beam”) that propagates towards an interior surface of a side 320c of the optical scanner 390, where the optical beam 303b-2 has an angle ( [symbol] ) (sometimes referred to as, “first reflected angle”) relative to a third normal of the side 320c of the optical scanner 390. That is, the side 320b reflects the optical beam 303b-1 because the angle ( [symbol] ) of the optical beam 303b-1 is greater than a predetermined angle relative to the second normal of the side 320b. In some embodiments, the angle ( [symbol] ) of the optical beam 303b-2 is different from the angle ( [symbol] ) of the optical beam 303b-1.

The side 320c of the optical scanner 390 refracts the optical beam 303b-2 based on angle ( [symbol] ) to generate an optical beam 303b-3 (sometimes referred to as, “second reflected beam”) that propagates through the window 330, and in some embodiments, towards one of the objects 308, where the optical beam 303b-3 has an angle ( [symbol] ) (sometimes referred to as, “second refracted angle”) relative to a third normal of the side 320c of the optical scanner 390.

The optical beam 303b-2 strikes the side 320c of the optical scanner 390 at a point of origin 353 on the side 320c while the optical scanner 390 is in the rotational position (P3b), where a first distance between the point of origin 353b and the window 330 is smaller than a second distance between a midpoint on the side 320c and the window 330.

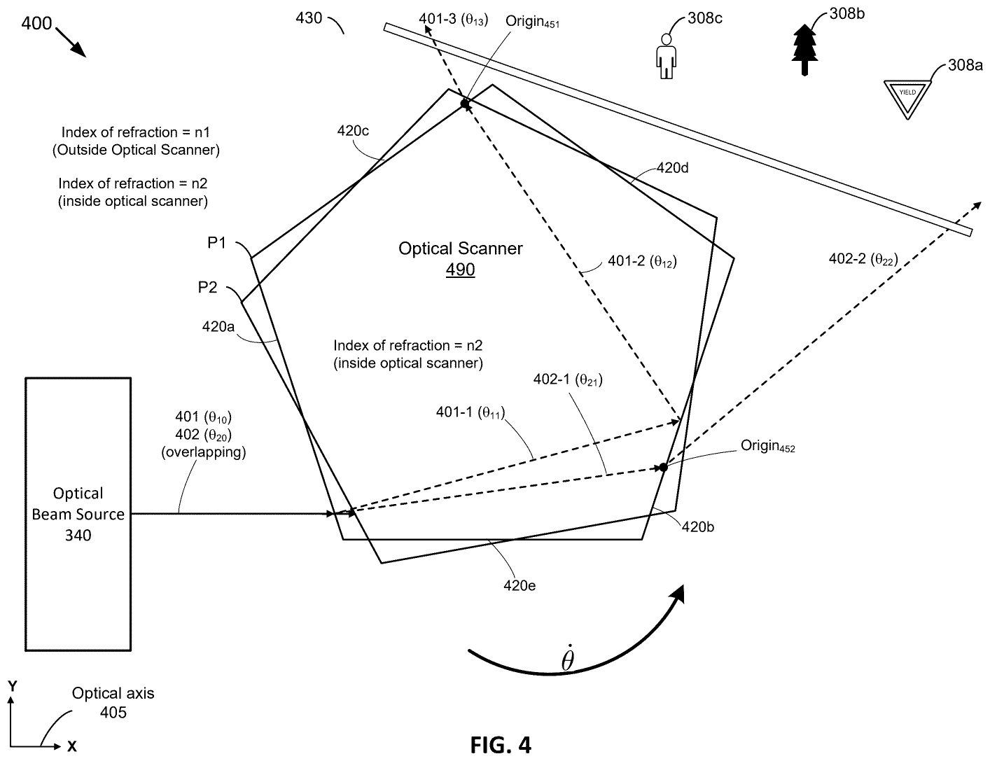

FIG. 4 is a block diagram illustrating an example environment for producing a field of view in an FMCW LIDAR system using a pentagonally-shaped optical scanner, according to some embodiments. The environment 400 includes the optical beam source 340, a window 430, and object 308 (e.g., objects 308a, 308b, 308c).

The environment 400 includes optical scanner 490 that is positioned adjacent to the window 430. Similar to optical scanner 390 in FIG. 3, the optical scanner 490 is coupled to the motor 120, thereby allowing the LIDAR control system 110 to control the motor 120 in order to rotate the optical scanner 490 about an axis in a counter-clockwise or clockwise direction across a plurality of rotational positions (e.g., rotational angles) each corresponding to different time periods (e.g., t1, etc.). Although FIG. 4 shows only a select number of rotational positions (e.g., P1, P2) for the optical scanner 490, the optical scanner 490 may be in any rotational position at any particular time during its rotation.

Environment 400 demonstrates that the angle of the optical beam striking a side of the optical scanner 490 affects whether the side of the optical scanner 490 will refract or reflect the optical beam, as well as, the angle of the resultant refracted or reflected optical beam. For example, the optical beam source 340 may transmit an optical beam 401 toward a side 420a of the optical scanner 490 when the optical scanner 490 is in rotational position (P1) during a first time period (e.g., time 1). The optical beam 401 strikes the side 420a of the optical scanner 490 at angle ( [symbol] ) relative to a first normal vector of the side 420a of the optical scanner 490.

The side 420a of the optical scanner 490 refracts the optical beam 401 based on angle ( [symbol] ) to generate an optical beam 401-1 that propagates through the side 420a of the optical scanner 490 and toward an interior surface of a side 420b of the optical scanner 490. That is, the side 420a refracts the optical beam 401 because the angle ( [symbol] ) of the optical beam 401 is less than a predetermined angle relative to the first normal of the side 420a, where the predetermined angle is based on the refractive index (n₁) of the environment that the optical beam 401 is traveling from and the refractive index (n₂) of the environment in which the optical beam 401 is traveling towards.

The optical beam 401-1 has an angle ( [symbol] ) relative to a second normal of the side 420b of the optical scanner 490.

The side 420b of the optical scanner 490 reflects the optical beam 401-1 based on angle ( [symbol] ) to generate an optical beam 401-2 that propagates towards an interior surface of a side 420c of the optical scanner 490, where the optical beam 401-2 has an angle ( [symbol] ) relative to a third normal of the side 420c of the optical scanner 490. That is, the side 420b reflects the optical beam 401-1 because the angle ( [symbol] ) of the optical beam 401-1 is greater than a predetermined angle relative to the second normal of the side 420b. In some embodiments, the angle ( [symbol] ) of the optical beam 401-1 is different from the angle ( [symbol] ) of the optical beam 401-2.

The side 420c of the optical scanner 490 refracts the optical beam 401-2 based on angle ( [symbol] ) to generate an optical beam 401-3 that propagates through the window 430, and in some embodiments, towards one of the objects 308, where the optical beam 401-3 has an angle ( [symbol] ) relative to a third normal of the side 420c of the optical scanner 490.

The optical beam 401-2 strikes the side 420c of the optical scanner 390 at a point of origin 451 on the side 420c while the optical scanner 490 is in the rotational position (P1), where a first distance between the point of origin 451 and the window 430 is smaller than a second distance between a midpoint on the side 420c and the window 430.

Now, the process is repeated for a second optical beam. For example, the optical beam source 340 may transmit an optical beam 402 toward the side 420a of the optical scanner 490 when the optical scanner 490 is in the rotational position (P2) during a second time period (e.g., time 2). The optical beam 402 strikes the side 420a of the optical scanner 490 at angle ( [symbol] ) relative to the first normal vector of the side 420a of the optical scanner 490.

The side 420a of the optical scanner 490 refracts the optical beam 402 based on angle ( [symbol] ) to generate an optical beam 402-1 that propagates through the side 420a of the optical scanner 490 and toward an interior surface of the side 420b of the optical scanner 490. That is, the side 420a refracts the optical beam 402 because the angle ( [symbol] ) of the optical beam 402 is less than a predetermined angle relative to the first normal of the side 420a, where the predetermined angle is based on the refractive index (n₁) of the environment that the optical beam 402 is traveling from and the refractive index (n₂) of the environment in which the optical beam 402 is traveling towards. The optical beam 402-1 has an angle ( [symbol] ) relative to the second normal of the side 420b of the optical scanner 490.

The side 420b of the optical scanner 490 refracts the optical beam 402-1 based on angle ( [symbol] ) to generate an optical beam 402-2 that propagates through the window 430, and in some embodiments, towards one of the objects 308, where the optical beam 402-2 has an angle ( [symbol] ) relative to the second normal of the side 420b of the optical scanner 490.

The optical beam 402-1 strikes the side 420b of the optical scanner 390 at a point of origin 452 on the side 420b while the optical scanner 490 is in the rotational position (P1), where a first distance between the point of origin 452 and the window 430 is smaller than a second distance between a midpoint on the side 420b and the window 430.

Thus, the angle ( [symbol] ) of the optical beam 402-1 is different from the angle ( [symbol] ) of the optical beam 401-1 because the angle ( [symbol] ) of the optical beam 401 is different from the angle ( [symbol] ) of the optical beam 402-1.

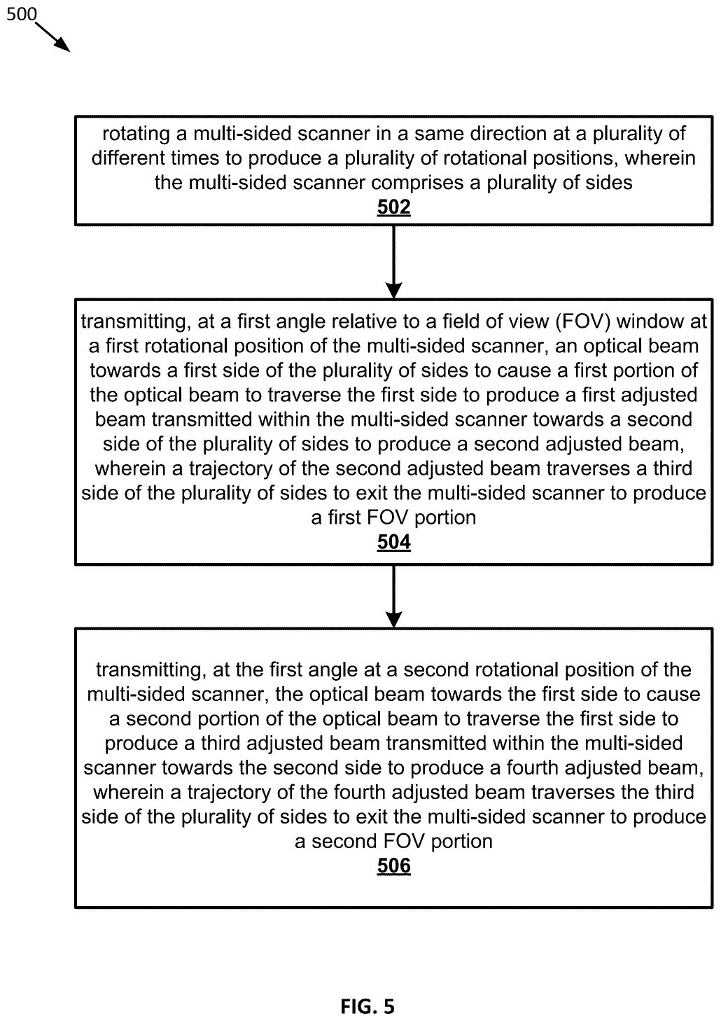

FIG. 5 is a flow diagram illustrating an example method for producing a field of view in a frequency modulated continuous wave (FMCW) light detection and ranging (LIDAR) system, according to some embodiments. Additional, fewer, or different operations may be performed in the method depending on the particular arrangement. In some embodiments, some or all operations of method 500 may be performed by one or more processors executing on one or more computing devices, systems, or servers (e.g., remote/networked servers or local servers). In some embodiments, method 500 may be performed by a signal processing unit, such as signal processing unit 112 in FIG. 1. In some embodiments, method 500 may be performed by any of the components (e.g., optical scanner 390, optical beam source 340, etc.) of environment 300 in FIG. 3, and/or the components of environment 400 in FIG. 4. Each operation may be re-ordered, added, removed, or repeated.

In some embodiments, the method 500 may include the operation 502 of rotating a multi-sided scanner (e.g., optical scanner 390, optical scanner 490) in a same direction at a plurality of different times to produce a plurality of rotational positions. In some embodiments, the multi-sided scanner includes a plurality of sides. In some embodiments, the method 500 may include the operation 504 of transmitting, at a first angle relative to a field of view (FOV) window at a first rotational position of the multi-sided scanner, an optical beam towards a first side of the plurality of sides to cause a first portion of the optical beam to traverse the first side to produce a first adjusted beam transmitted within the multi-sided scanner towards a second side of the plurality of sides to produce a second adjusted beam, wherein a trajectory of the second adjusted beam traverses a third side of the plurality of sides to exit the multi-sided scanner to produce a first FOV portion. In some embodiments, the method 506 includes transmitting, at the first angle at a second rotational position of the multi-sided scanner, the optical beam towards the first side to cause a second portion of the optical beam to traverse the first side to produce a third adjusted beam transmitted within the multi-sided scanner towards the second side to produce a fourth adjusted beam, wherein a trajectory of the fourth adjusted beam traverses the third side of the plurality of sides to exit the multi-sided scanner to produce a second FOV portion.

The preceding description sets forth numerous specific details such as examples of specific systems, components, methods, and so forth, in order to provide a good understanding of several embodiments of the present disclosure. It will be apparent to one skilled in the art, however, that at least some embodiments of the present disclosure may be practiced without these specific details. In other instances, well-known components or methods are not described in detail or are presented in simple block diagram format in order to avoid unnecessarily obscuring the present disclosure. Thus, the specific details set forth are merely exemplary.

While this specification contains many specific implementation details, these should not be construed as limitations on the scope of any embodiments or of what may be claimed, but rather as descriptions of features specific to particular embodiments. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination. Moreover, the separation of various system components in the embodiments described above should not be understood as requiring such separation in all embodiments, and it should be understood that the described program components and systems can generally be integrated together in a single software product or packaged into multiple software products. Particular embodiments may vary from these exemplary details and still be contemplated to be within the scope of the present disclosure.

Reference throughout this specification to “one embodiment” or “an embodiment” means that a particular feature, structure, or characteristic described in connection with the embodiments included in at least one embodiment. Thus, the appearances of the phrase “in one embodiment” or “in an embodiment” in various places throughout this specification are not necessarily all referring to the same embodiment. In addition, the term “or” is intended to mean an inclusive “or” rather than an exclusive “or.” Although the operations of the methods herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be in an intermittent or alternating manner.

The above description of illustrated implementations of the present embodiments, including what is described in the Abstract, is not intended to be exhaustive or to limit the present embodiments to the precise forms disclosed. While specific implementations of, and examples for, the present embodiments are described herein for illustrative purposes, various equivalent modifications are possible within the scope of the present embodiments, as those skilled in the relevant art will recognize. The words “example” or “exemplary” are used herein to mean serving as an example, instance, or illustration. Any aspect or design described herein as “example” or “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or”. That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form. Moreover, use of the term “an embodiment” or “one embodiment” or “an implementation” or “one implementation” throughout is not intended to mean the same embodiment or implementation unless described as such. Furthermore, the terms “first,” “second,” “third,” “fourth,” etc. as used herein are meant as labels to distinguish among different elements and may not necessarily have an ordinal meaning according to their numerical designation.

What is claimed is:

1. An apparatus, comprising:
an optical scanner having two or more surfaces including a reflective surface and a rear surface, wherein the optical scanner is mounted to rotate about a scanner axis;
a control system operatively coupled to the optical scanner;
a motor, operatively coupled to the control system, mounted in proximity to the optical scanner and having a shaft coupled to the optical scanner, wherein the shaft rotates about a shaft axis that is parallel to the scanner axis thereby causing the optical scanner to rotate about the scanner axis responsively to rotation of the shaft, and wherein the motor rotates the optical scanner to each of a set of positions at a respective time based on instructions from the control system; and
an optical beam source, operatively coupled to the control system, positioned behind the optical scanner and configured to transmit an optical beam toward the optical scanner while the motor rotates the optical scanner about the scanner axis.

2. The apparatus of claim 1, wherein the set of positions correspond to 360 degrees around the scanner axis.

3. The apparatus of claim of claim 1, wherein the reflective surface comprises a mirror.

4. The apparatus of claim 1, wherein the transmitted optical beam is associated with a target environment.

5. The apparatus of claim 1, wherein the motor rotates the optical scanner about the scanner axis according to a scan pattern.

6. The apparatus of claim 1, further comprising:
an enclosure that encompasses the optical scanner and the optical beam source.

7. The apparatus of claim 1, wherein the transmitted optical beam produces a field of view.

8. The apparatus of claim 1, wherein the shaft is associated with a galvanometer.

9. A method, comprising:
mounting an optical scanner to rotate about a scanner axis, wherein the optical scanner has two or more surfaces including a reflective surface and a rear surface;
rotating, via a motor mounted in proximity to the optical scanner, a shaft coupled to the optical scanner about a shaft axis that is parallel to the scanner axis, thereby causing the optical scanner to rotate about the scanner axis responsively to rotation of the shaft, wherein the motor rotates the optical scanner to each of a set of positions at a respective time; and
transmitting, via an optical beam source positioned behind the optical scanner, an optical beam towards the optical scanner while the motor rotates the optical scanner about the scanner axis.

10. The method of claim 9, wherein the set of positions correspond to 360 degrees around the scanner axis.

11. The method of claim 9, wherein the reflective surface comprises a mirror.

12. The method of claim 9, wherein the transmitted optical beam is associated with a target environment.

13. The method of claim 9, wherein the motor rotates the optical scanner about the scanner axis according to a scan pattern.

14. The method of claim 9, wherein the transmitted optical beam produces a field of view.

15. An apparatus, comprising:
an optical scanner having two or more surfaces including a reflective surface and a rear surface, wherein the optical scanner is mounted to rotate about a scanner axis; and
a motor, operatively coupled to the optical scanner, mounted in proximity to the optical scanner and having a shaft coupled to the optical scanner, wherein the shaft rotates about a shaft axis that is parallel to the scanner axis thereby causing the optical scanner to rotate about the scanner axis responsively to rotation of the shaft, and wherein the motor rotates the optical scanner to each of a set of positions at a respective time.

16. The apparatus of claim 15, wherein the set of positions correspond to 360 degrees around the scanner axis.

17. The apparatus of claim 15, wherein the reflective surface comprises a mirror.

18. The apparatus of claim 15, wherein the motor rotates the optical scanner about the scanner axis according to a scan pattern.

19. The apparatus of claim 15, further comprising:
an enclosure that encompasses the optical scanner.

20. The apparatus of claim 15, wherein the shaft is associated with a galvanometer.
